(19) United States
(12) Patent Application Publication
(10) Pub. No.: US 2016/0243908 A1
(43) Pub. Date: Aug. 25, 2016

(54) SEMI-AUTONOMOUS TRAILER HITCH

(71) Applicant: GM Global Technology Operations LLC, Detroit, MI (US)

(72) Inventors: Richard J. Lannen, Royal Oak, MI (US); Wade W. Bryant, Grosse Pointe Farms, MI (US); Edward J. Miller, Flushing, MI (US)

(21) Appl. No.: 14/627,517

(22) Filed: Feb. 20, 2015

(51) Int. Cl. B60D 1/26; B60W 10/04; B60W 10/20; B60W 30/165; B60D 1/64

(52) U.S. Cl. CPC B60D 1/26; B60W 30/165; B60D 1/64; B60W 10/20; B60W 10/04

(57) ABSTRACT

A number of variations may include a product comprising: a semi-autonomous trailer hitch comprising a coupler; a towed device structure, wherein the coupler and the towed device structure are pivotally attached to each other; and at least one sensor on at least one of the coupler or the towed device structure.

### TECHNICAL FIELD

The field to which the disclosure generally relates to includes trailer hitches.

### BACKGROUND

A wheeled device may include a trailer hitch.

### SUMMARY OF ILLUSTRATIVE VARIATIONS

One variation may include a product comprising: a semi-autonomous trailer hitch comprising a coupler; a towed device structure, wherein the coupler and the towed device structure are pivotally attached to each other; and at least one sensor on at least one of the coupler or the towed device structure.

Another variation may include a method comprising: controlling at least one towed device comprising: providing a towed device with electrically propelled wheels and steering with a semi-autonomous trailer hitch, wherein the semi-autonomous trailer hitch includes at least one sensor; detecting at least one operating condition of a tow vehicle with the at least one sensor; relaying the at least one operating condition to the towed device with electrically propelled wheels and steering; and controlling the towed device with electrically propelled wheels and steering to match the at least one operating condition of the tow vehicle.

Another variation may include a method comprising: towing multiple towed devices using a single tow vehicle comprising: providing a first towed device having a first semi-autonomous trailer hitch and at least one second towed device having a second semi-autonomous trailer hitch; attaching the first towed device to a tow vehicle; attaching the at least one second towed device to the first towed device; detecting at least one operating condition of the tow vehicle using the first semi-autonomous trailer hitch; relaying the at least one operating condition of the tow vehicle to the first towed device; controlling the first towed device to match the at least one operating condition of the tow vehicle; detecting at least one operating condition of the first towed device with the second semi-autonomous trailer hitch; relaying the at least one operating condition of the first towed device to the second towed device; and controlling the second towed device to match the at least one operating condition of the first towed device.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of a semi-autonomous trailer hitch according to a number of variations.

FIG. 2 illustrates a close-up perspective view of a semi-autonomous trailer hitch according to a number of variations.

FIG. 3 illustrates a close-up perspective view of a semi-autonomous trailer hitch according to a number of variations.

FIG. 4 illustrates a close-up perspective view of a semi-autonomous trailer hitch according to a number of variations.

### DETAILED DESCRIPTION OF ILLUSTRATIVE VARIATIONS

The following description of the variations is merely illustrative in nature and is in no way intended to limit the scope of the invention, its application, or uses.

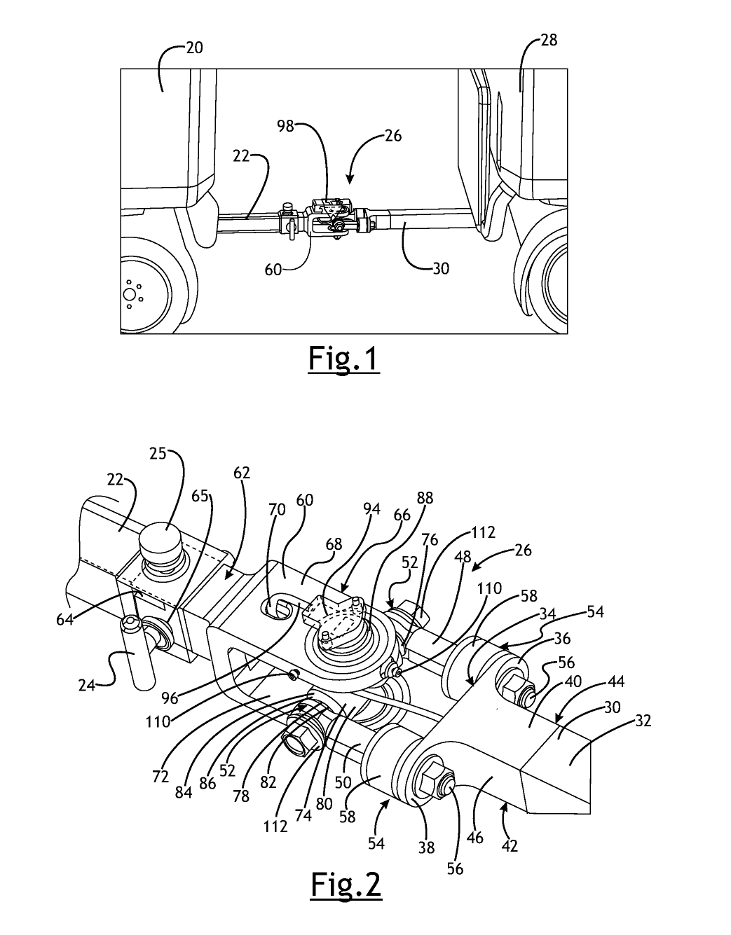

FIGS. 1-4 illustrate a number of variations including a semi-autonomous trailer hitch 26. In a number of variations, a semi-autonomous trailer hitch 26 may be constructed and arranged for use with any number of towed devices having electrically propelled wheels and electrically operated steering 28 including, but not limited to, an electric trailer. In a number of variations, a semi-autonomous trailer hitch 26 may be constructed and arranged to detect various operating conditions including, but not limited to, the speed and/or direction, of a tow vehicle 20. The semi-autonomous trailer hitch 26 may then send signals to the towed device 28 relaying the one or more operating conditions of the tow vehicle 20 so that the electrically steered and/or propelled device 28 may match the operating condition of the tow vehicle 20. In a number of variations, the semi-autonomous trailer hitch 26 may allow for the use of multiple towed devices 28 to be towed using a single tow vehicle 20.

In a number of variations, a semi-autonomous trailer hitch 26 may include a towed device structure 30 and a towed device coupler 60 which may be pivotally and/or rotatably attached to each other. In a number of variations, the towed device structure 30 may extend from the towed device 28. In a number of variations, a towed device structure 30 may include a rail 32 and may be constructed and arranged to attach to the towed device coupler 60, as will be discussed hereafter. The rail 32 may be any number of shapes including, but not limited to, square or rectangular. The rail 32 may include a front wall 34, a top wall 40, a bottom wall 42, a first side wall 44, and a second side wall 46, a variation of which is illustrated in FIG. 2. In one variation, the front wall 34 may include a first extension 36 which may extend outward adjacent the first side wall 44 and a second extension 38 which may extend outward adjacent the second side wall 46. The first and second extensions 36, 38 may be constructed and arranged to accommodate a first connector component 48 and a second connector component 50.

In a number of variations, the first connector component 48 and the second connector component 50 may include a first end 52 and a second end 54 and may extend perpendicular from the front wall 34 of the rail 32, a variation of which is illustrated in FIG. 2. The first end 52 may be constructed and arranged to attach to the towed device coupler 60, as will be discussed hereafter. In a number of variations, the second ends 54 of the first connector component 48 and the second connector component 50 may be attached to the first extension 36 and the second extension 38, respectively. In one variation, the towed device structure 30 and the first and second connector components 48, 50 may be a single continuous unit. In another variation, the towed device structure 30 and the first and second connector components 48, 50 may comprise several pieces which may be attached together. In one variation, the first and second connector components 48, 50 may be attached to the towed device structure 30 via one or more mechanical fasteners 56, a variation of which is illustrated in FIG. 2. In a number of variations, the second ends 52 of the connector components 48, 50 may also be constructed and arranged to include one or more load sensors 58 which may communicate to the towed device 28 the force/acceleration created by the tow vehicle 20, as will be discussed hereafter.

In a number of variations, a semi-autonomous trailer hitch 26 towed device coupler 60 may include a first end 62 and a second end 66. In a number of variations, the first end 62 of the coupler 60 may be square or rectangular in shape and may extend outward from the towed device coupler 60 and may be constructed and arranged to extend within a tow bar 22, a variation of which is illustrated in FIG. 2, or around the tow bar 22 (not illustrated). In a number of variations, the first end 62 may include one or more locking features 64, 65 which may be used to lock the semi-autonomous trailer hitch 26 to the tow bar 22 on the tow vehicle 20. Any number of locking features 64, 65 may be used, including, but not limited to, a cutout 64 which may accommodate a cinch/latch 24 on the tow bar 22 and/or an opening 65 which may accommodate a mechanical fastener 25, variations of which are illustrated in FIG. 2. The first end 62 may also include a cutout or hollow portion 53, a variation of which is illustrated in FIG. 4.

In a number of variations, the second end 66 may be a “C-shaped” and may include a top member 68 and a bottom member 72 which may each be planar and which may each extend parallel to each other, a double axis rotational joint 74 which may extend between the top member 68 and the bottom member 72, a variation of which is illustrated in FIG. 2. In a number of variations, the top member 68 may include an opening 70, a variation of which is also illustrated in FIG. 2, which may allow a wire 96, which may be connected to a wired angle sensor 94, to pass through the top member 68 and into the towed device structure 30 to the towed device's 28 electronics, as will be discussed hereafter. In another variation, the top member 68 may not include an opening, a variation of which is illustrated in FIG. 4.

In a number of variations, the double axis rotational joint 74 may be rotatably attached between the top member 68 and the bottom member 72 so that it may rotate around a vertical axis 90. In a number of variations, the double axis rotational joint 74 may be “T-shaped” and may include a first arm 76 and a second arm 78 which may extend outward from each other. In a number of variations, each arm 76, 78 may be cylindrical in shape and may include a first surface 80, a second surface 82, and a lip 84 which may extend therebetween. In a number of variations, the diameter of the second surface 82 may be smaller than the diameter of the first surface 80. The lip 84 may extend at an angle 86 between the first surface 80 and the second surface 82, a variation of which is illustrated in FIG. 2. The double axis rotational joint 74 may be attached to the top member 72 and the bottom member 72 in any number of variations including, but not limited to, one or more mechanical fasteners 114.

In a number of variations, the double axis rotational joint 74 may be constructed and arranged so that the towed device structure 28 may be attached to the double axis rotational joint 74 so that it may pivot upward or downward along a horizontal axis 92 and also rotate around a vertical axis 90, a variation of which is illustrated in FIG. 4. The towed device structure 30 may be attached to the double axis rotational joint 74 in any number of variations including, but not limited to, attaching the first end 52 of the first connector 48 to the first arm 76 of the double axis rotational joint 74 and the first end 52 of the second connector component 50 to the second arm 78 of the double axis rotational joint 74 via one or more mechanical fasteners 112.

In a number of variations, one or more load sensors 58 may be attached to the first and/or second connector components 48, 50 which may measure the pressure during a towing event. The pressure or the tow force may be translated by the one or more load sensor(s) 58 into an electrical signal which through calibration may be analogous to the load applied to the tow vehicle 20. In one variation, two load sensors 58 may be used to create a directional vector. In a number of variations, the one or more load sensors 58 may relay the electrical signal to the towed device's 28 electrical propulsion system so that the towed device 28 may match the tow vehicle 20 speed and/or acceleration. Any number of load sensors 58 may be used including, but not limited to, wired load cells or wireless load cells. The use of the one or more load sensors 58 on the semi-autonomous trailer hitch 26 may reduce towing loads transmitted to the tow vehicle 20.

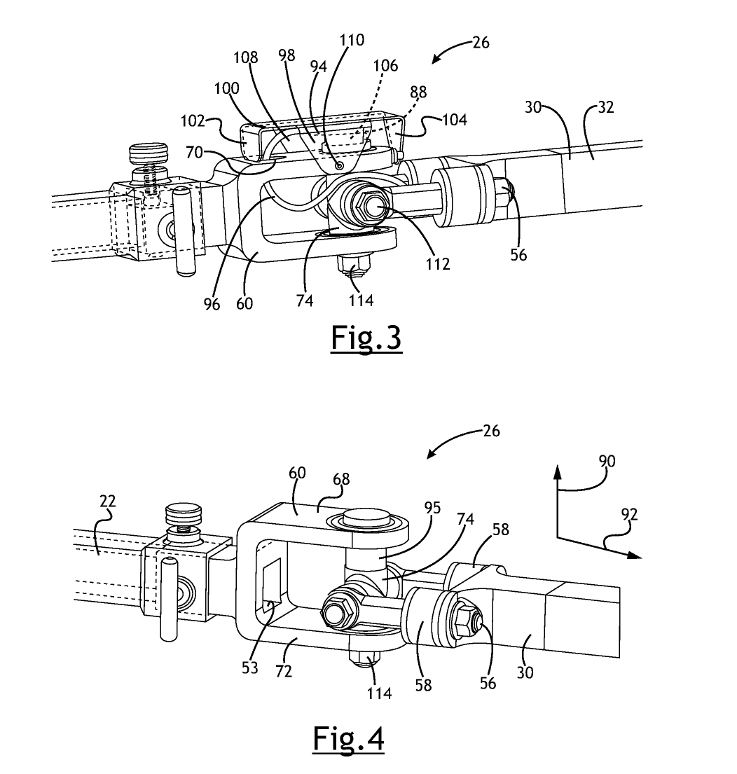

In a number of variations, an angle sensor 94, 95 may be attached to the double axis rotational joint 74. Any number of angle sensors 94, 95 may be used including, but not limited to, wired angled sensors and/or wireless angle sensors. In one variation, the angle sensor 94 may be attached to the top surface 88 of the double axis rotational joint 74 so that it extends above the top member 68 of the towed device coupler 60, a variation of which is illustrated in FIG. 2. In a number of variations, an angle sensor shield 98, variations of which are illustrated in FIGS. 1 and 3, may be attached to the towed device coupler 60 and may protect the angle sensor 94 from contaminants. In one variation, the angle sensor shield 98 may include a top wall 100, a front wall 102, a rear wall 104, a first side wall 106, and a second side wall 108. The top wall 100 may be parallel to the top member 68. The front wall 102, rear wall 104, first side wall 106, and second side wall 108 may extend downward from the top wall 100 so that they may each be substantially perpendicular to the top member 68. The angle sensor shield 98 may be attached to the towed device coupler 60 in any number of variations including, but not limited to, attaching at least one of the front wall 102, first and second side walls 160, 108, and/or the rear wall 104 to the towed device coupler 60 with one or more mechanical fasteners 110. In another variation, an angle sensor 95 may be located on the double axis rotational joint 74 within the towed device coupler 60 between the top member 68 and the bottom member 72, a variation of which is illustrated in FIG. 4.

In a number of variations, the angle sensor 94, 95 may send a signal of the direction of the tow vehicle 20 to the towed device 28 so that the towed device 28 may turn and move in the same direction as the tow vehicle 20. In a number of variations, the angle sensor 94, 95 may detect and measure the angle between the towed device 28 and the tow vehicle 20. The angle detected may then be transmitted into an electrical signal which through calibration may determine a steering change in the towed device 28. The sensor 94, 95 may then relay the electrical signal to the electrical steering system of the towed device 28 so that the towed device 28 may match the direction and/or turn radius of the tow vehicle 20. The use of an angle sensor 94, 95 on the semi-autonomous trailer hitch 26 may improve the steering control and turn radius of the tow vehicle 20 and the towed device(s) 28.

In one variation, wiring 96 from the angle sensor 94 and the one or more load sensors 58 may extend through the towed device structure rail 32 and may be operatively connected to the towed device's 28 electrical system so that it may send signals to the electrical system so that the electrical system may control the towed device 28 based on the conditions of the tow vehicle 20. In another variation, one or more wireless sensors may be used which may reduce or eliminate the use of wires in the semi-autonomous trailer hitch 26.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a semi-autonomous trailer hitch comprising: a coupler; a towed device structure, wherein the coupler and the towed device structure are pivotally attached to each other; and at least one sensor on at least one of the coupler or the towed device structure.

Variation 2 may include a product as set forth in Variation 1 wherein the coupler is constructed and arranged to attach to a tow vehicle and wherein the towed device structure is constructed and arranged to attach to a towed device.

Variation 3 may include a product as set forth in any of Variations 1-2 wherein the at least one sensor is constructed and arranged to detect at least one operating condition of a tow vehicle and to relay the at least one operating condition to the towed device.

Variation 4 may include a product as set forth in any of Variations 1-3 wherein the coupler further comprises a rotational joint which attaches to the towed device structure so that the towed device structure may rotate along a vertical axis and a horizontal axis.

Variation 5 may include a product as set forth in any of Variations 1-4 wherein the coupler is C-shaped and includes a first member, a second member, and a joint component which extends rotatably between the first member and the second member, and wherein the towed device structure includes a rail and a first connector component and a second connector component attached to the rail, and wherein the first connector component and the second connector component are pivotally attached to the joint component.

Variation 6 may include a product as set forth in any of Variations 1-5 wherein the at least one sensor is an angle sensor attached to the joint component.

Variation 7 may include a product as set forth in any of Variations 1-5 wherein the at least one sensor is a first load sensor attached to the first connector component and a second load sensor attached to the second connector component.

Variation 8 may include a product as set forth in any of Variations 1-5 wherein the at least one sensor is an angle sensor attached to the joint component and a first load sensor attached to the first connector component and a second load sensor attached to the second connector component.

Variation 9 may include a product as set forth in any of Variations 1-6 and 8 wherein the angle sensor extends above the top member.

Variation 10 may include a product as set forth in any of Variations 1-6 and 8-9 further comprising an angle sensor shield attached to the coupler.

Variation 11 may include a product as set forth in any of Variations 1-6 and 8 wherein the angle sensor extends between the top member and the bottom member.

Variation 12 may include a product as set forth in any of Variations 1-11 further comprising a towed device attached to the semi-autonomous trailer hitch.

Variation 13 may include a product as set forth in Variation 12 wherein the towed device is an electrically steered and propelled device.

Variation 14 may include a product as set forth in any of Variations 12-13 wherein the at least one sensor is electrically connected to an electrical system in the electrically steered and propelled device.

Variation 15 may include a product as set forth in any of Variations 12-13 wherein the at least one sensor sends signals to an electrical system in the electrically steered and propelled device wirelessly.

Variation 16 may include a method comprising: controlling at least one towed device comprising: providing a towed device with electrically propelled wheels and steering with a semi-autonomous trailer hitch, wherein the semi-autonomous trailer hitch includes at least one sensor; detecting at least one operating condition of a tow vehicle with the at least one sensor; relaying the at least one operating condition to the towed device with electrically propelled wheels and steering; and controlling the towed device with electrically propelled wheels and steering to match the at least one operating condition of the tow vehicle.

Variation 17 may include a method as set forth in Variation 16 wherein the at least one operating condition is at least one of the speed or the direction of the tow vehicle.

Variation 18 may include a method as set forth in any of Variations 16-17 wherein the at least one sensor is at least one of an angle sensor or at least one load sensor.

Variation 19 may include a method as set forth in Variation 18 wherein the angle sensor detects the direction of the tow vehicle and the at least one load sensor detects the speed of the tow vehicle.

Variation 20 may include a method comprising: towing multiple towed devices using a single tow vehicle comprising: providing a first towed device having a first semi-autonomous trailer hitch and at least one second towed device having a second semi-autonomous trailer hitch; attaching the first towed device to a tow vehicle; attaching the at least one second towed device to the first towed device; detecting at least one operating condition of the tow vehicle using the first semi-autonomous trailer hitch; relaying the at least one operating condition of the tow vehicle to the first towed device; controlling the first towed device to match the at least one operating condition of the tow vehicle; detecting at least one operating condition of the first towed device with the second semi-autonomous trailer hitch; relaying the at least one operating condition of the first towed device to the second towed device; and controlling the second towed device to match the at least one operating condition of the first towed device.

The above description of select variations within the scope of the invention is merely illustrative in nature and, thus, variations or variants thereof are not to be regarded as a departure from the spirit and scope of the invention.

What is claimed is:

1. A product comprising:
a semi-autonomous trailer hitch comprising:
a coupler;
a towed device structure, wherein the coupler and the towed device structure are pivotally attached to each other; and
at least one sensor on at least one of the coupler or the towed device structure.

2. The product of claim 1 wherein the coupler is constructed and arranged to attach to a tow vehicle and wherein the towed device structure is constructed and arranged to attach to a towed device.

3. The product of claim 1 wherein the at least one sensor is constructed and arranged to detect at least one operating condition of a tow vehicle and to relay the at least one operating condition to the towed device.

4. The product of claim 1 wherein the coupler further comprises a rotational joint which attaches to the towed device structure so that the towed device structure may rotate along a vertical axis and a horizontal axis.

5. The product of claim 1 wherein the coupler is C-shaped and includes a first member, a second member, and a joint component which extends rotatably between the first member and the second member, and wherein the towed device structure includes a rail and a first connector component and a second connector component attached to the rail, and wherein the first connector component and the second connector component are pivotally attached to the joint component.

6. The product of claim 5 wherein the at least one sensor is an angle sensor attached to the joint component.

7. The product of claim 5 wherein the at least one sensor is a first load sensor attached to the first connector component and a second load sensor attached to the second connector component.

8. The product of claim 5 wherein the at least one sensor is an angle sensor attached to the joint component and a first load sensor attached to the first connector component and a second load sensor attached to the second connector component.

9. The product of claim 6 wherein the angle sensor extends above the top member.

10. The product of claim 1 further comprising an angle sensor shield attached to the coupler.

11. The product of claim 6 wherein the angle sensor extends between the top member and the bottom member.

12. The product of claim 1 further comprising a towed device attached to the semi-autonomous trailer hitch.

13. The product of claim 12, wherein the towed device is an electrically steered and propelled device.

14. The product of claim 12 wherein the at least one sensor is electrically connected to an electrical system in the electrically steered and propelled device.

15. The product of claim 12 wherein the at least one sensor sends signals to an electrical system in the electrically steered and propelled device wirelessly.

16. A method comprising:
controlling at least one towed device comprising:
providing a towed device with electrically propelled wheels and steering with a semi-autonomous trailer hitch, wherein the semi-autonomous trailer hitch includes at least one sensor;
detecting at least one operating condition of a tow vehicle with the at least one sensor;
relaying the at least one operating condition to the towed device with electrically propelled wheels and steering; and
controlling the towed device with electrically propelled wheels and steering to match the at least one operating condition of the tow vehicle.

17. The method of claim 16 wherein the at least one operating condition is at least one of the speed or the direction of the tow vehicle.

18. The method of claim 16 wherein the at least one sensor is at least one of an angle sensor or at least one load sensor.

19. The method of claim 18 wherein the angle sensor detects the direction of the tow vehicle and the at least one load sensor detects the speed of the tow vehicle.

20. A method comprising:
towing multiple towed devices using a single tow vehicle comprising:
providing a first towed device having a first semi-autonomous trailer hitch and at least one second towed device having a second semi-autonomous trailer hitch;
attaching the first towed device to a tow vehicle;
attaching the at least one second towed device to the first towed device;
detecting at least one operating condition of the tow vehicle using the first semi-autonomous trailer hitch;
relaying the at least one operating condition of the tow vehicle to the first towed device;
controlling the first towed device to match the at least one operating condition of the tow vehicle;
detecting at least one operating condition of the first towed device with the second semi-autonomous trailer hitch;
relaying the at least one operating condition of the first towed device to the second towed device; and
controlling the second towed device to match the at least one operating condition of the first towed device.
